(19) United States
(12) Patent Application Publication
(10) Pub. No.: US 2018/0238234 A1
(43) Pub. Date: Aug. 23, 2018

(54) FUEL INJECTION DEVICE FOR A GAS TURBINE

(71) Applicant: Rolls-Royce Deutschland Ltd & Co KG, Blankenfelde-Mahlow (DE)

(72) Inventors: Holger KLINGER, Blankenfelde-Mahlow (DE); Peter SCHOBER, Blankenfelde-Mahlow (DE)

(21) Appl. No.: 15/897,783

(22) Filed: Feb. 15, 2018

(30) Foreign Application Priority Data
Feb. 21, 2017 (DE) 10 2017 202 800.9

(51) Int. Cl. F02C 7/12; F02C 7/22; F02C 7/228; F02C 7/232

(52) U.S. Cl. CPC F02C 7/12; F02C 7/222; F02C 7/228; F05D 2270/301; F05D 2220/323; F05D 2240/35; F05D 2260/20; F02C 7/232

(57) ABSTRACT

A fuel injection device includes a plurality of main burners and pilot burners. Each main burner is connected to a main distribution line, and each pilot burner is connected to a pilot distribution line. A setting device provides fuel to the main fuel line and/or to the pilot fuel line. A control unit adjusts the setting device between a first mode for exclusive pilot burner operation and a second mode for joint pilot burner operation and main burner operation such that, in the first mode, a tank connection is connected to a first line section of the main fuel line, and a second line section of the main fuel line is connected to the pilot supply line to conduct fuel through the main fuel line before it is supplied to the pilot fuel line to cool the main burner.

This application claims priority to German Patent Application DE102017202800.9 filed Feb. 21, 2017, the entirety of which is incorporated by reference herein.

The present invention relates to a fuel injection device of a gas turbine, in particular an aircraft gas turbine. Further, the present invention relates to a gas turbine, in particular an aircraft gas turbine, with a fuel injection device as well as a method for operating a fuel injection device of a gas turbine.

Fuel injection devices for aircraft gas turbines are known from the state of the art in different embodiments, with known fuel injection devices comprising a plurality of main burners and a plurality of pilot burners. During idling operation of the gas turbine, it is sufficient if the pilot burners are active. If high performance is required, for example during ascent, the main burners as well as the pilot burners are operated. When the main burners as well as the pilot burners are operated, the cooling of the burners is realized by means of the supplied fuel, which is relatively cool. What is known from US 2013/0061599 A1 is a fuel injection device that provides a cooling of the main burners when only the pilot burners are operated. Here, a fuel flow is branched off from the supply to the pilot burners to a line which usually supplies fuel to the main burners. However, this branching occurs in a fuel nozzle, so that the fuel already has a relatively high temperature, as the fuel nozzle is arranged directly at the combustion chamber of the gas turbine. Thus, only a suboptimal cooling of the main burner is possible.

It is therefore the objective of the present invention to provide a fuel injection device as well as a gas turbine with a fuel injection device and a method that provides an improved cooling of the main burners in a mode in which only the pilot burners are operated, while at the same time having a simple structure and being easy and cost-effective to manufacture.

The objective is achieved through a fuel injection device with the features of claim 1 and a gas turbine with the features of claim 9 as well as a method with the features of claim 11. The subclaims respectively show preferred further development of the invention.

The fuel injection device with the features of claim 1 facilitates an improved cooling of the main burners when only the pilot burners of the fuel injection device are operated. Thus, any damage to the main burners can be reliably avoided. Here, it is not necessary to provide an additional cooling network or the like for cooling the main burners, but rather existing lines can be used in the fuel injection device. According to the invention, this is achieved by the fuel injection device having a plurality of main burners, a plurality of pilot burners, as well as a main fuel line. The main fuel line has a first and a second line section as well as a main distribution line. The line sections are respectively separately connected to the main distribution line. Further, a pilot fuel line with at least one pilot supply line and at least one pilot distribution line is provided. It is to be understood that the pilot burners is preferably divided into two groups to improve an ignitability. Each main burner is connected to the main distribution line, and each pilot burner is connected to the pilot distribution line. Further, the fuel injection device comprises a setting device for providing fuel to the pilot burners and/or the main burners, as well as a control unit. The control unit is configured for adjusting the setting device between a first mode for exclusive pilot burner operation and a second mode for joint pilot burner operation and main burner operation. Here, the control unit is configured for connecting, in the first mode, a tank connection to the first line section of the main fuel line, and for connecting the second line section of the main fuel line to the pilot supply line. Thus, the control unit ensures that the fuel is conducted through the main distribution line of the main fuel line before being supplied to the pilot fuel line so as to achieve cooling of the main burners that are arranged at the main fuel line. Thus, cooler fuel is first conducted into the main fuel line to the main distribution line to cool the main burner and is subsequently guided back to the pilot supply line via the second line section of the main fuel line, and from there to the pilot burners. The second line section is thus used as a return line. Thus, even though already slightly heated fuel reaches the pilot burners in exclusive operation of the pilot burner, the slightly heated fuel at the pilot burners is still not sufficient in the case of exclusive pilot burner operation to cool the pilot burners to a sufficient degree, in particular because the performance of the pilot burners is usually considerably lower than a performance of the main burners.

It is further preferred if the control unit is configured for setting the setting device in the second mode for a joint operation of pilot burners and main burners in such a manner that in the second mode a tank connection is connected to a pilot supply line, the first and second line section of the main fuel line. In this manner, sufficient amount von fuel can be supplied to the main burners via the first and second line section, and at the same time a sufficient amount of fuel can be supplied to the pilot burners via the pilot supply line.

It is particularly preferred if, for providing fuel to the pilot burners and/or the main burners, the setting device comprises a first and a second valve unit that are arranged in a row between the tank connection on the one hand and the main fuel line and the pilot fuel line on the other. Here, the first and second valve units can be way valves or alternatively also spool valves. It is particularly preferred if the first valve unit is a 3/2-way valve or a valve unit that has the function of a 3/2-way valve, and the second valve unit is a 5/2-way valve or a valve unit that has the function of a 5/2-way valve.

It is particularly preferred if a first and a second connection line is arranged between the first valve unit and the second valve unit. In this manner, it is possible that it is determined by means of the first valve unit which mode is selected, i.e., exclusive pilot burner operation or joint pilot burner operation and main burner operation, or exclusive main burner operation, or a partial load operation of both burners. Then, a cooling of burners as it may possibly be necessary can be realized by means of the second valve unit.

To ensure a structure of the fuel injection device that is as simple as possible, it is particularly preferable if the first valve unit is embodied in every position in such a manner that a tank connection is connected to the second connection line. It is further preferred if the second valve unit is embodied in every position in such a manner that the first valve unit is connected to the first line section of the main fuel line.

For a particularly compact structure, the main distribution line of the main fuel line is a closed ring line. It is particularly preferred if the closed ring line is a circular ring line. Preferably, the main burners are arranged at an inner circumference of the circular ring line.

It is further preferred if a first connection of the first line section is arranged at the main distribution line, and a second connection of the second line section is arranged at the main distribution line in such a manner that the closed ring line is divided into a first and a second ring section having the same line lengths. Thus, if the closed ring line is a circular ring line, the first and second connections are preferably arranged so as to be facing each other at 180°.

According to a further preferred embodiment of the present invention, the fuel injection device further comprises a plurality of stop valves, wherein respectively one stop valve is arranged between a main burner and the main distribution line of the main fuel line. The stop valves are preferably pressure-controlled stop valves which are opened when a predefined pressure is present. Thus, the main burners can be engaged in a pressure-controlled manner. It is alternatively preferred if the stop valves are valves that are controlled by a signal, wherein the control can be performed in a hydraulic or electrical manner

It is further preferred if the fuel injection device has an even number of main burners.

Further, the present invention relates to a gas turbine, in particular an aircraft gas turbine, with a fuel injection device according to the invention.

Further, the present invention relates to a method for operating a fuel injection device of a gas turbine, in particular an aircraft gas turbine. The gas turbine comprises a plurality of main burners and a plurality of pilot burners, wherein, in a first mode for operating the fuel injection device, only the pilot burners are operated, wherein fuel is conducted through the main fuel line before being supplied into a pilot fuel line for cooling the main burners. At that, the main fuel line has a first and a second line section, wherein one of the two line sections is used as a return line via which the fuel is conducted to the pilot fuel line. Thus, the main burners can be cooled with the relatively cold fuel, and the slightly heated fuel is subsequently used for operating the pilot burners.

In the method according to the invention, a tank connection is further connected to a pilot supply line, a first line section, and a second line section of the main fuel line in a second mode for a joint pilot burner operation and main burner operation.

In the following, the invention will be described based on a preferred exemplary embodiment in connection with the drawing. Herein:

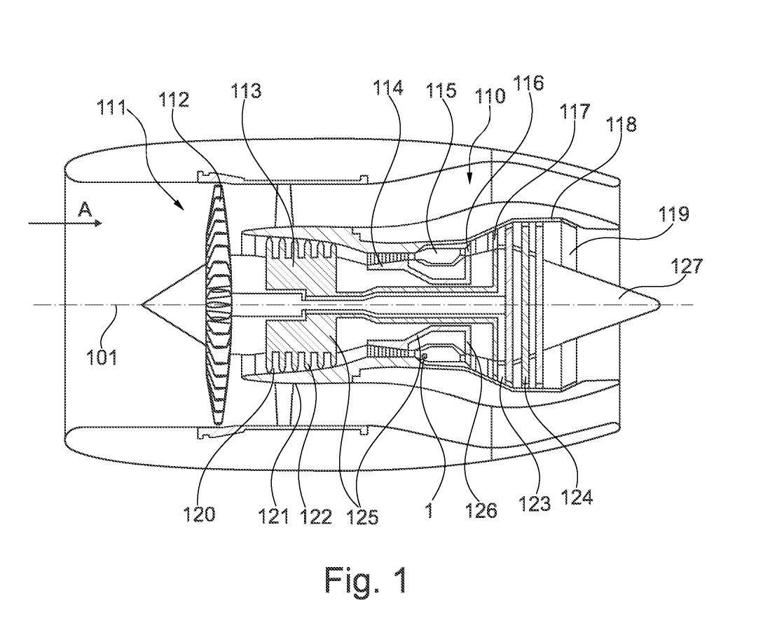

FIG. 1 shows a gas turbine engine with a fuel injection device according to the invention,

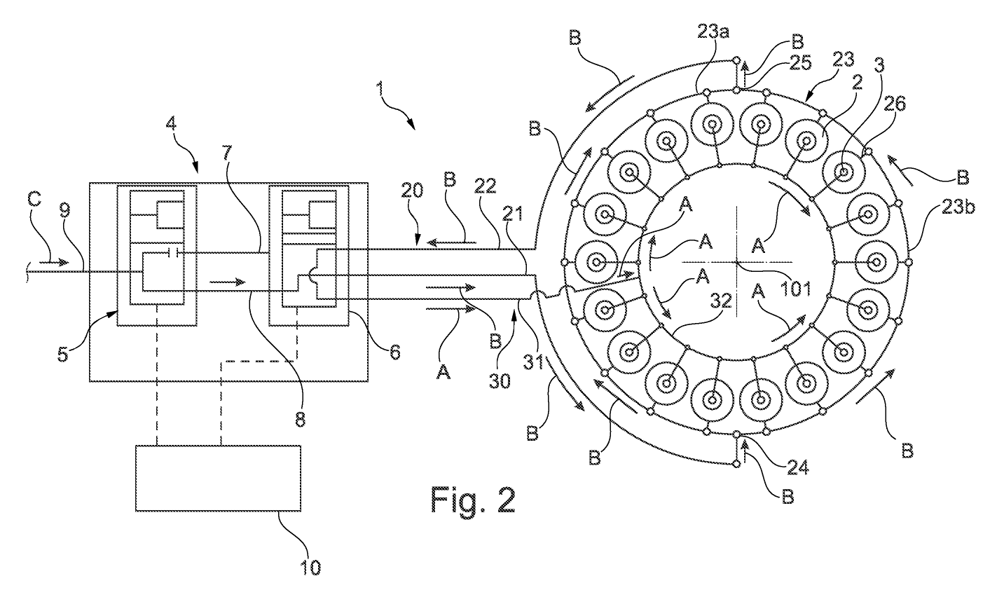

FIG. 2 shows a schematic rendering of the fuel injection device according to the present invention in a first mode in exclusive pilot burner operation,

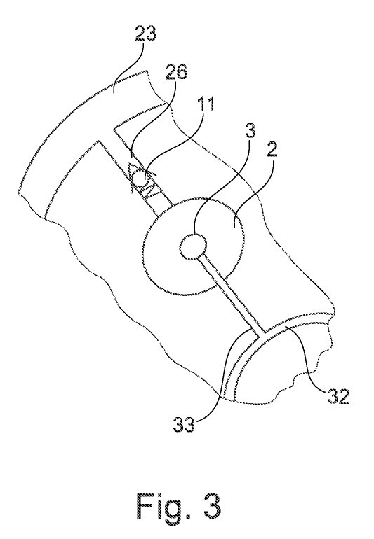

FIG. 3 shows a schematic enlarged rendering of main burners and pilot burners of FIG. 2, and

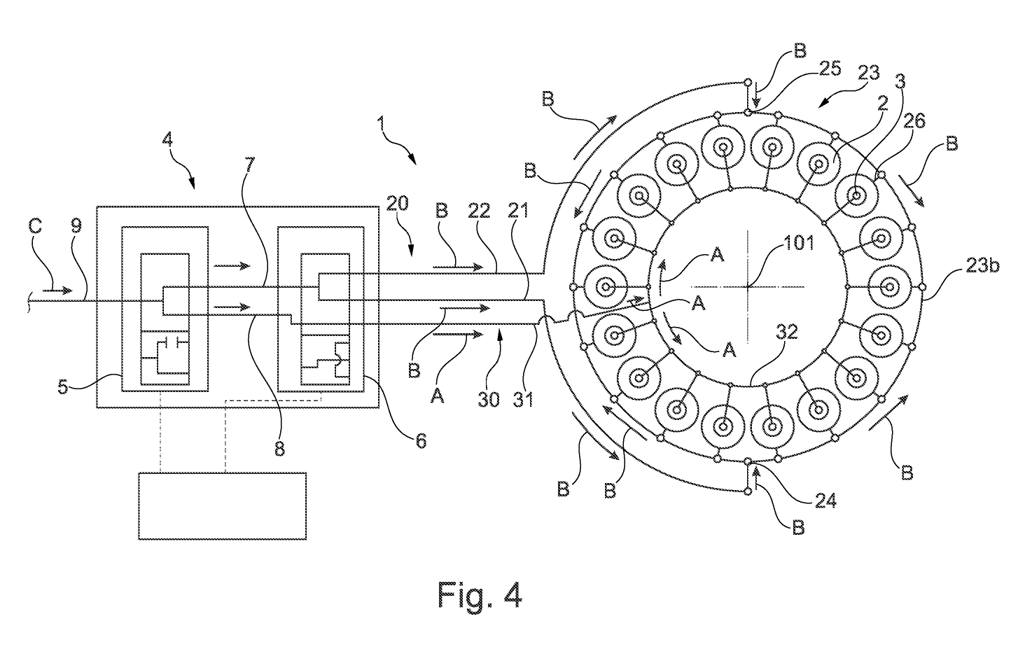

FIG. 4 shows a schematic rendering of the fuel injection device in a second mode, in which the pilot burners and the main burners are operated.

The gas turbine engine 110 according to FIG. 1 represents a general example of a turbomachine in which the invention may be used. The gas turbine engine 110 is configured in a conventional manner and comprises, arranged successively in flow direction, an air intake 111, a fan 112 that rotates inside a housing, a medium-pressure compressor 113, a high-pressure compressor 114, a combustion chamber 115, a high-pressure turbine 116, a medium-pressure turbine 117, and a low-pressure turbine 118 as well as an exhaust nozzle 119, which are all arranged around a central engine axis 101.

The medium-pressure compressor 113 and the high-pressure compressor 114 respectively comprise multiple stages, of which each has an arrangement of fixedly arranged stationary guide vanes 120 that extends in the circumferential direction, with the stationary guide vanes 120 being generally referred to as stator vanes and projecting radially inward from the core engine housing 121 through the compressors 113, 114 into a ring-shaped flow channel. Further, the compressors have an arrangement of compressor rotor blades 122 that project radially outward from a rotatable drum or disc 125, and are coupled to hubs 126 of the high-pressure turbine 116 or the medium-pressure turbine 117.

The turbine sections 116, 117, 118 have similar stages, comprising an arrangement of stationary guide vanes 123 projecting radially inward from the housing 121 through the turbines 116, 117, 118 into the ring-shaped flow channel, and a subsequent arrangement of turbine blades/vanes 124 projecting outwards from the rotatable hub 126. During operation, the compressor drum or compressor disc 125 and the blades 122 arranged thereon as well as the turbine rotor hub 126 and the turbine rotor blades/vanes 124 arranged thereon rotate around the engine central axis 101.

FIGS. 2, 3 and 4 show a detailed rendering of a fuel injection device 1 according to a preferred exemplary embodiment of the invention.

As can be seen in FIG. 2, the fuel injection device 2 comprises a plurality of main burners 2 and a plurality of pilot burners 3. At that, a pilot burner 3 is assigned to each main burner 2, with a number of main burners 2 preferably being even. The main burners 2 are supplied with fuel via a main fuel line 20. The main fuel line 20 comprises a first line section 21, a second line section 22, and a main distribution line 23. As can be seen in FIG. 2, the first line section 21 and the second line section 22 are respectively separately connected to the main distribution line 23.

The main distribution line 23 is a closed ring line that is embodied as a circle. Here, the plurality of main burners 2 is preferably arranged at an inner circumference of the main distribution line 23.

Here, a first connection 24 of the first line section 21 is arranged at the main distribution line 23, and a second connection 25 of the second line section 22 and the main distribution line 23 are arranged at the main distribution line 23 in such a manner that the main distribution line 23 is divided into a first ring section 23a and a second ring section 23b having a similar or identical line length. As can be seen in FIG. 2, the first connection 24 and the second connection 25 thus face each other at the main distribution line 23 preferably at 180°.

As can be seen in FIG. 3, each main burner 2 is connected to a main distribution line 23 via a stub 26. Respectively one check valve 11 is arranged in the stub 26. In this manner, a pressure-controlled supply of the main burner can be realized depending on the pressure in the main distribution line 23.

As is further shown in FIG. 3, the pilot burners 3 are arranged centrally inside the main burners.

The fuel injection device 1 further comprises a pilot fuel line 30 that comprises a pilot supply line 31 and a pilot distribution line 32. The pilot distribution line 32 is also a closed ring line, and in this exemplary embodiment is also embodied as a circular ring. Each pilot burner 3 is connected to the pilot distribution line 32 (cf. FIG. 3) via a stub 33.

It is to be understood that, with a view to rendering the illustration clearer, only respectively one main burner and one pilot burner are indicated in FIGS. 2 and 4. The check valves and the stubs 26, 33 are also not indicated in FIGS. 2 and 4.

The fuel injection device 1 further comprises a setting device 4 for providing fuel to the pilot burners and/or the main burners. The setting device 4 comprises a first valve unit 5 and a second valve unit 6. Further, a control unit 10 is provided, controlling the first valve unit 5 and the second valve unit 6.

A first connection line 7 and a second connection line 8 are provided between the first valve unit 5 and the second valve unit 6. The reference signs 9 indicate a tank connection via which fuel is supplied from the tank to the setting device 4, optionally via a fuel measurement system.

The fuel injection device 1 can now be operated in different operating modes. Depending on a performance requirement of the gas turbine, it is for example possible to operate only the pilot burners 3, or for example operate the pilot burners 3 and the main burners 2 in the event of a high performance being required.

In a first mode that is shown in FIG. 2, only the pilot burners 3 are operated. At that, the first valve unit 5 is brought into such a position that the tank connection 9 is connected exclusively to the second connection line 8. The second valve unit 6 is brought into a position in which the second connection line 8 is connected to the first line section 21 of the main fuel line 20. Further, it is ensured that the second line section 22 is connected to the pilot supply line 31 by means of the second valve unit 6.

Thus, fuel is supplied into the first line section 21 through the first valve unit 5 and the second valve unit 6 via the tank connection 9, as indicated by arrow C. Fuel is supplied via the first line section 21 to the main distribution line 23, as indicated in FIG. 2 by the arrows B. At the first connection 24, the fuel flow branches off via the two ring sections 23a, 23b to the second connection 25. The fuel flows from the second connection 25 via the second line section 22 back to the second valve unit 6. The second valve unit 6 is embodied in such a manner that the second line section 22 is connected to the pilot supply line 31 (cf. FIG. 2). Thus, the fuel flowing back from the main distribution line 23 flows into the pilot supply line 31 via the second line section 22, and from there into the pilot distribution line 32 to the pilot burners 3.

Thus, during exclusive pilot burner operation, the fuel is first conducted into the main distribution line 23 via the first line section 21, and back into the pilot fuel line 30 via the second line section 22. In this manner, the still cool fuel is first conducted from the tank connection 9 directly to the main distribution line 23, and there can cool the main burners 2, which are also heated up in exclusive pilot burner operation. In this manner, the fuel flow can absorb some heat and is conducted via the second line section 22 back to the second valve unit 6 and from there into the pilot fuel line 30, and is supplied to the pilot burners 3.

By comparison, FIG. 4 shows the fuel injection device 1 in a second mode in which the plurality of main burners 2 as well as the plurality of pilot burners 3 is active. Here, the control unit 10 is configured for setting the setting device 4 in the second mode for joint pilot burner and main burner operation. In the second mode, the tank connection 9 is connected via the first valve unit 5 to the first connection line 7 and the second connection line 8 to the second valve unit 6. In the second valve unit 6, the first connection line 7 is connected to the first line section 21 and the second line section 22 of the main fuel line 20. The second connection line 8 is connected via the second valve unit 6 to the pilot supply line 31. Thus, the main distribution line 23 is supplied with fuel through the first and second line section 21, 22. In both cases, cooling of the main burners and the pilot burners is effected by the relatively cool fuel from the tank.

As can be seen by comparing FIGS. 2 and 4, the flow direction has thus reversed in the second line section 22 in the second mode. The second mode is for example used in aircraft gas turbines during ascent or cruising flight.

Thus, a cooling of main burners 2, in particular also in exclusive pilot burner operation, can be facilitated in the present invention. Here, no further conduits are necessary, but rather cooling during exclusive pilot burner operation can be achieved by adjusting the connection between the first and the second line section 21, 22 of the main fuel line 20.

It is to be understood that, in the described exemplary embodiment, a 3/2-way valve is used as the first valve unit 5, and a 5/2-way valve is used in the second valve unit 6. However, other valves, in particular spool valves or multiple single valves facilitating a respective realization of the line connections, may be used.

Further, it is to be understood that by providing two line sections 21, 22 a large amount of fuel can be introduced into the main distribution line 23 during operation of the plurality of main burners 2. In this manner, it is also possible to cover power peaks.

What is thus proposed is a fuel injection device with a main fuel line 20 with a first and second line section 21, 22, wherein one of the two line sections functions as a return line in exclusive pilot burner operation so that fuel is conducted from the main distribution line 23 back into the pilot fuel line 20. In this manner, a particularly compact and space-saving structure, which is in particular characterized by a low weight, can be achieved.

### PARTS LIST

1 fuel injection device
2 main burner
3 pilot burner
4 setting device
5 first valve unit
6 second valve unit
7 first connection line
8 second connection line
9 tank connection
10 control unit
11 check valve
20 main fuel line
21 first line section
22 second line section
23 main distribution line
23a first ring section
23b second ring section
24 first connection
25 second connection
26 stub
30 pilot fuel line
31 pilot supply line
32 pilot distribution line
33 stub
101 engine central axis
110 gas turbine engine/core engine
111 air intake
112 fan
113 medium-pressure compressor (compactor)
114 high-pressure compressor
115 combustion chamber
116 high-pressure turbine
117 medium-pressure turbine
118 low-pressure turbine
119 exhaust nozzle
120 guide vanes
121 core engine housing
122 compressor rotor blades
123 guide vanes
124 turbine blades/vanes
125 compressor drum or compressor disc
126 turbine rotor hub
127 outlet cone
A flow of the fuel inside the pilot fuel line
B flow of the fuel inside the main fuel line
C flow of the fuel from the tank

1. Fuel injection device, comprising:
a plurality of main burners,
a plurality of pilot burners,
a main fuel line with a first line section, a second line section and a main distribution line,
a pilot fuel line with a pilot supply line and a pilot distribution line,
wherein each main burner is connected to the main distribution line, and each pilot burner is connected to the pilot distribution line,
a setting device for providing fuel to the main fuel line and/or to the pilot fuel line, and
a control unit configured for adjusting the setting device between a first mode for exclusive pilot burner operation and a second mode for joint pilot burner operation and main burner operation in such a manner that, in the first mode, a tank connection is connected to the first line section of the main fuel line, and the second line section of the main fuel line is connected to the pilot supply line to conduct the fuel through the main fuel line before it is supplied to the pilot fuel line so as to achieve a cooling of the main burners.

2. Fuel injection device according to claim 1, wherein the control unit is configured for setting the setting device in the second mode for joint pilot burner operation and main burner operation in such a manner that, in the second mode, the tank connection is connected to the pilot supply line, the first line section, and the second line section.

3. Fuel injection device according to claim 1, wherein the setting device comprises a first valve unit and a second valve unit that are arranged in a row between the tank connection and the main fuel line as well as the pilot fuel line.

4. Fuel injection device according to claim 3, wherein a first connection line and a second connection line are arranged between the first valve unit and the second valve unit.

5. Fuel injection device according to claim 4, wherein the first valve unit connects the tank connection to the second connection line in every position.

6. Fuel injection device according to claim 5, wherein the second valve unit connects the first valve unit to the first line section of the main fuel line in every position.

7. Fuel injection device according to claim 1, wherein the main distribution line of the main fuel line is a closed ring line.

8. Fuel injection device according to claim 7, wherein a first connection of the first line section at the main distribution line and a second connection of the second line section at the main distribution line divides the ring line into a first ring section and a second ring section having the same line lengths.

9. Fuel injection device according to claim 1, further comprising a plurality of stop valves, in particular pressure-controlled stop valves, wherein respectively one stop valve is arranged between a main burner and the main distribution line.

10. Gas turbine, in particular aircraft gas turbine, comprising a fuel injection device according to claim 1.

11. Method for operating a fuel injection device of a gas turbine, in particular aircraft gas turbine, with a plurality of main burners and a plurality of pilot burners, wherein, in a first mode, only the pilot burners are operated, wherein a fuel is conducted through a main fuel line connected to the main burners for cooling the main burner before it is supplied into a pilot fuel line, wherein the main fuel line has a first and a second line section and one of the two line sections is used as the return line via which the fuel is conducted to the pilot fuel line.

12. Method according to claim 11, wherein the pilot burner and the main burner are operated jointly in a second mode, wherein fuel is supplied into the pilot fuel line and the main fuel line simultaneously.
